(19) United States
(12) Patent Application Publication
(10) Pub. No.: US 2025/0353355 A1
(43) Pub. Date: Nov. 20, 2025

(54) CAM GEAR, DRIVE UNIT AND AIR VENTS WITH THE CAM GEAR

(71) Applicant: Matikon GmbH & Co. KG, Horb am Neckar (DE)

(72) Inventor: Ulf Lothar BASTIAN, Pfalzgrafenweiler (DE)

(73) Assignee: Matikon GmbH & Co. KG, Horb am Neckar (DE)

(21) Appl. No.: 19/203,854

(22) Filed: May 9, 2025

(30) Foreign Application Priority Data
May 15, 2024 (DE) 10 2024 113 588.3

(51) Int. Cl. B60H 1/34

(52) U.S. Cl. CPC B60H 1/3421; B60H 2001/3478

(57) ABSTRACT

The invention relates to an air vent with a cam gear with a drive element which can be swiveled by means of a geared motor, which, when pivoting in a first swivel direction in a first swivel angle section, deflects slats of a first set of slats of the air vent via a first coupling element and, when pivoting further in the first swivel direction in a subsequent second swivel angle section, swivels the slats back again. When pivoting in the opposite direction in a second swivel direction, the drive element deflects slats of a second set of slats in a third swivel angle section and swivels them back when the drive element is swiveled further in the second swivel direction over a fourth swivel angle section.

The invention relates to a cam gear with the features of the general term of claim 1 as well as a drive unit and an air vent with the cam gear with the features of the general terms of claims 13 and 14.

DE 10 2020 108 169 A1 discloses an air vent for a motor vehicle with a pivotable slat as an air deflection element and a pivotable throttle flap as an air volume control element, both of which are driven by a rotatable cam disk. The cam disk has a W-shaped control cam into which a link pin engages, which protrudes from a pivoting lever of the slat in such a way that the slat is swiveled when the control disk is rotated. To swivel the throttle valve, the cam disk is rotated in such a way that one edge of the cam disk abuts against a link pin that protrudes from a swivel lever of the throttle valve in such a way that the throttle valve is swiveled.

DE 10 2021 119 416 A1 describes a gear in which the drive element has a first sensor. However, the first sensor is part of the first coupling element and therefore cannot sense a first deflection curve of the first coupling element. The first sensor senses a groove of the drive. In addition, the first coupling element, like the drive, can pivot about the same pivot axis D. The first coupling element pivots together with the drive. This movement of the first coupling element within the groove is purely translational.

The object of the invention is to propose a cam gear for pivoting in particular one or two air deflection elements or an air deflection element and an air volume control element of an air vent.

According to the invention, this task is solved by the features of claim 1.

The cam gear according to the invention with the features of claim 1 has a drive element which is pivotable about a swivel axis, which is referred to here as the drive swivel axis. Furthermore, the cam gear according to the invention has a first coupling element which is pivotable about a first swivel axis. In embodiments of the invention, the cam gear can have one or more further coupling elements and/or swivel axis, but embodiments of the invention without a further coupling element and/or without further swivel axis are also possible. The task of the coupling element is a direct or indirect transmission of a swivel movement of the drive element to any output element per se, whereby the output element can also be swiveled and/or the movement can be converted and the output element can be displaceable. For example, the output element can be a pivotable air deflection element or a pivotable or displaceable air volume control element such as a throttle valve or a throttle slide.

The drive element has a first sensor at a radial distance from the drive swivel axis and the first coupling element has a first deflection curve, which is scanned by the first sensor of the drive element. As with the coupling element, one or more further sensors and/or deflection curves can be present, but do not have to be. The term “scanning” refers to moving the sensor along the deflection curve, which transfers the swivel movement of the drive element to the first coupling element.

Starting from a swivel position of the drive element and the first coupling element, referred to here as the home position, the first sensor of the drive element scans the first deflection curve of the first coupling element when the drive element is swiveled about the drive swivel axis in a first swivel direction within a first swivel angle section. The first swivel angle section can immediately follow the home position or the drive element must be swiveled through a swivel angle starting from its home position until it reaches the first swivel angle section. By scanning, i.e. moving the first sensor along the first deflection curve, the first sensor swivels the first coupling element in a first deflection direction around the first swivel axis into a swivel position via the first deflection curve, which is referred to here as the distracted position. The swivel movement of the drive element in the first swivel direction in the first swivel angle section is therefore transmitted to the first coupling element via the first sensor and the first deflection curve and deflects it, whereby the swivel angle and swivel speed of the first coupling element and the drive element can be the same or different.

In addition to the first sensor, the drive element of the cam gear according to the invention has a first resetter at a radial distance from the drive swivel axis and the first coupling element has a first reset curve. Here too, one or more further resetters and/or reset curves may be present, but need not be present. In particular, the resetter has a different, especially greater, distance from the drive swivel axis than the sensor. If the drive element is swiveled further in the first swivel direction in a second swivel angle section, the first resetter scans the first reset curve and swivels the first coupling element back into the home position about the first swivel axis in a resetting direction opposite to the first deflection direction. Thus, according to the invention, the first coupling element is swiveled from the distracted position back to its home position by continuing to pivot lever the drive element in the same direction in which it was swiveled to displace the first coupling element.

The second swivel angle section can be directly adjacent to the first swivel angle section or there is a swivel angle distance between the first and second swivel angle sections.

The drive element can be swiveled back to the home position in a second swivel direction opposite to the first swivel direction. The drive element may also be swiveled further in the first swivel direction until it reaches its home position again.

The dependent claims have as their object advantageous embodiments and further embodiments of the invention stated in claim 1.

Preferably, the cam gear according to the invention is designed in such a way that the drive element does not move the first coupling element back over the first and second swivel angle sections when the drive element swivels about the drive swivel axis in the second swivel direction opposite to the first swivel direction. This means that when the drive element swivels back, the drive element does not move the first coupling element, but the first coupling element retains its swivel position. This makes it possible to displace the coupling element as far as desired and then swivel the drive element back into the home position without pivoting the distracted coupling element.

One embodiment of the invention provides that, when the drive element transitions from the first to the second swivel angle section, the first sensor comes free of the first deflection curve of the first coupling element and evades the coupling element by a movement transverse to an extension of the deflection curve. The first sensor does not have to move exactly transverse to the extension of the deflection curve; it is sufficient if the evasive movement of the first sensor has a component transverse to the extension of the first deflection curve. This embodiment of the invention enables the first coupling element to swivel back into the home position. This without the first sensor striking the first coupling element or the first deflection curve and blocking the first coupling element from pivoting back and preventing the reset.

In order to be able to avoid the first coupling element, the first sensor is spring-loaded in the embodiments of the invention, in particular transversely or with a movement component transverse to the extension of the first deflection curve. The first sensor can also be spring-loaded parallel to the drive swivel axis or parallel to the first swivel axis. The cam gear according to the invention can have a spring element that acts on the first sensor. Another possibility for a spring-loaded design of the first sensor is an arrangement of the first sensor on an elastic element, whereby the elastic element can, for example, be the drive element or a part of the drive element.

In order to be able to move two output elements independently of one another with the one drive element, a further development of the invention provides a second coupling element which can be swiveled about a swivel axis, which is referred to here as the second swivel axis. The second coupling element has a deflection curve, referred to here as the second deflection curve, which is scanned by the drive element. For this purpose, the second coupling element is arranged in relation to the drive element in such a way that the drive element swivels the second coupling element about its axis, i.e. the second swivel axis, in a direction referred to here as the second deflection direction when the second coupling element is in a home position and the drive element is swiveled about the drive swivel axis in the second swivel direction. The drive element then scans the second deflection curve, i.e. the drive element is or comes into contact with the second deflection curve or in any case moves along the second deflection curve and swivels the second coupling element into a distracted position. In the second swivel direction, the drive element is swiveled back into the home position, whereby the first coupling element is preferably not swiveled but remains in its swiveled position. This allows the two coupling elements to be distracted independently by pivoting the drive element in either the first or second swivel direction. A swivel position of the drive element for pivoting the second coupling element can be the distracted position, the home position or basically any swivel position.

A further development of the above embodiment of the invention provides a third coupling element which is pivotable about a third swivel axis and which is swiveled by the second coupling element. For this purpose, in this embodiment of the invention, the second coupling element has a second sensor at a radial distance from the second swivel axis, i.e. from the swivel axis of the second coupling element, and the third coupling element has a deflection curve, which is referred to here as the third deflection curve. The third deflection curve is scanned by the second sensor of the second coupling element during pivoting when the second coupling element is swiveled in a third swivel angle section in the second deflection direction. In doing so, the second coupling element swivels the third coupling element into a distracted position.

The second and/or third swivel axis can run parallel, at right angles or at a different angle to the drive swivel axis and/or the first swivel axis.

A further embodiment of the invention provides that the second coupling element has a second reset device and the third coupling element has a third reset curve, which the second reset device scans when the second coupling element is swiveled about the second swivel axis in a fourth swivel angle section in the second swivel direction. The second coupling element swivels the third coupling element back to its home position in a third reset direction opposite to the third deflection direction. Like the first coupling element, in this embodiment of the invention the third coupling element can be distracted into any swivel position and swiveled back again independently of the first coupling element.

In a preferred embodiment of the invention, the second coupling element does not swivel the third coupling element when pivoting in a fourth swivel direction opposite to the third swivel direction. As a result, the second coupling element can be swiveled back without pivoting the third coupling element, but the third coupling element remains in its swivel position.

During the transition of the second coupling element from the third to the fourth swivel angle section, in a preferred embodiment of the invention the second sensor comes free of the third deflection curve and avoids the third coupling element transversely or with a movement component transverse to the extension of the third deflection curve, so that the third coupling element can be swiveled back.

Like the first sensor, the second sensor is also spring-loaded in preferred embodiments of the invention. When spring-loaded, the second sensor moves in particular transversely or with a movement component transverse to the extension of the third deflection curve.

One embodiment of the invention provides for the second coupling element to have a return spring for pivoting back into the home position. As a result, it does not have to be swivel back by the drive element.

In embodiments of the invention, the second swivel axis of the second coupling element and/or the third swivel axis of the third coupling element extend at right angles or in a radial plane of the drive swivel axis of the drive element and/or in a radial plane of the first swivel axis of the first coupling element.

An advantage of all or at least several embodiments of the invention is that the first and the third coupling element can be swiveled back into the home position from any swivel position, which need not be known, by fully deflecting the drive element once from its home position in both directions and pivoting it back into the home position at the end. The drive element swivels in the first swivel direction over the first and second swivel angle sections and fully deflects the first coupling element, regardless of which swivel position it is in, and then swivels it back into the home position, and the drive element swivels in the opposite second swivel direction over the third and fourth swivel angle sections and fully deflects the third coupling element, also regardless of which swivel position it is in, via the second coupling element and swivels it back into the home position. All elements of the cam gear according to the invention are then in their home positions and the coupling elements can be distracted into any swivel position. This makes it possible, for example, to manually swivel the coupling elements into any desired swivel position and to swivel them back into the home positions with the drive element.

The subject of claim 13 is a drive unit with a version of the cam gear described above and an electric motor for pivoting the drive element.

The subject of claim 14 is an air vent with a version of the cam gear described above for pivoting or moving two air control elements independently of one another using a drive, for example an electric motor. Air vents are used to supply air to a passenger compartment of a motor vehicle. The air vent has two pivotable air deflection elements, in particular pivotable slats for directing an air flow or an air deflection element and an air volume control element, in particular a throttle valve or a throttle slide for controlling an air volume flowing through the air vent. The first coupling element of the cam gear is rigidly, flexibly or otherwise drive-connected to a first air deflection element of the air vent in such a way that the first coupling element swivels the air deflection element in one direction when it is distracted and the air deflection element swivels in an opposite direction when the first coupling element is swiveled back. The third coupling element is rigidly, flexibly or otherwise drive-connected to a second air deflection element or an air volume control element of the air outflow device in such a way that the third coupling element of the cam gear swivels or displaces the second air deflection element or the air volume control element of the air outflow device in one direction when the third coupling element is distracted. When pivoting back, the third coupling element of the cam gear swivels or distracts the second air deflection element or air volume control element back. With the cam gear according to the invention, the two air deflection elements or the air deflection element and the air volume control element can be swiveled independently of each other or the air volume control element can also be displaced, i.e. distracted and reset independently of each other.

The features and combinations of features, designs and embodiments of the invention mentioned above in the description, as well as the features and combinations of features mentioned below in the figure description and/or drawn in a figure, can be used not only in the combination indicated or drawn in each case, but also in basically any other combination or individually. Embodiments of the invention are possible which do not have all the features of a dependent claim. Individual features of a claim can also be replaced by other disclosed features or combinations of features. Embodiments of the invention are possible which do not have all of the features of the embodiment example, but rather a fundamentally arbitrary part of the characterized features of the embodiment example.

The invention is explained in more detail below with reference to an embodiment example shown in the drawing. It shows:

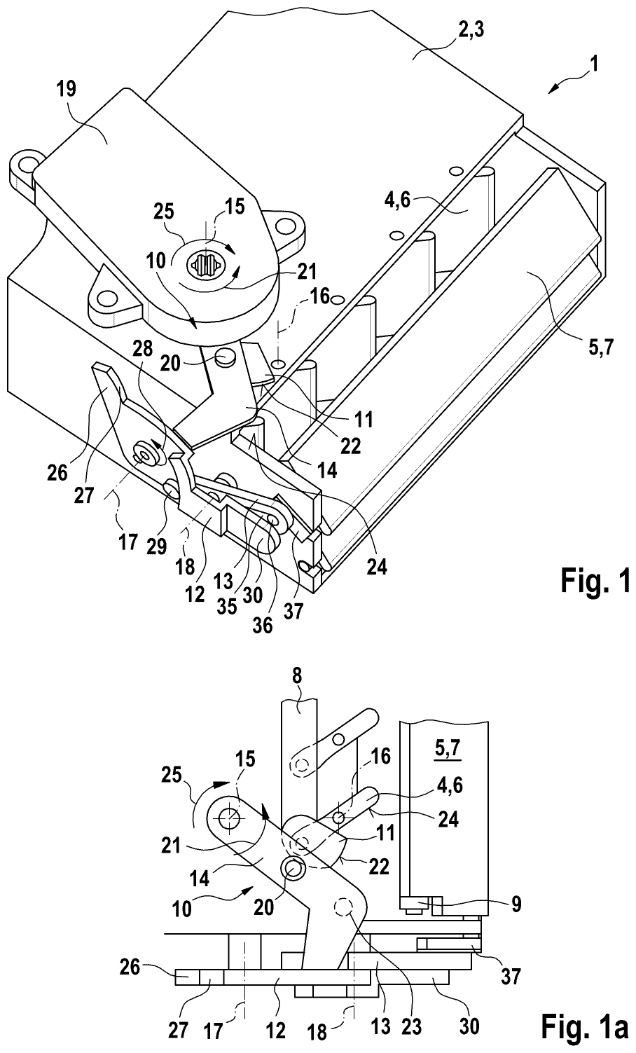

FIG. 1A perspective view of an air vent according to the invention with a cam gear according to the invention in a basic position;

FIG. 1a A view of a drive element and a first coupling element of the cam gear from FIG. 1 in the basic position;

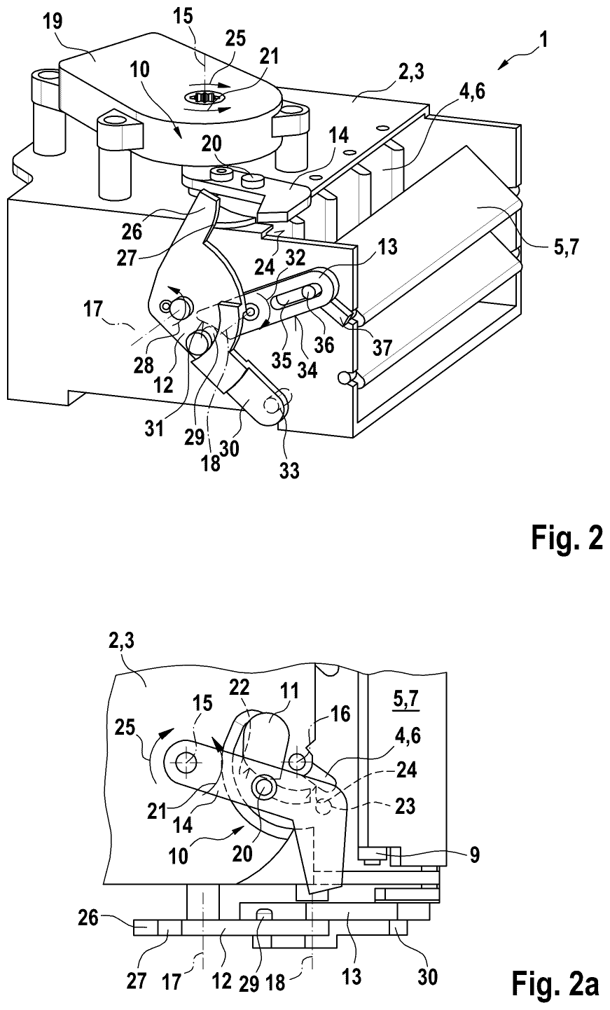

FIG. 2 the air vent from FIG. 1 in a distracted position;

FIG. 2a the drive element and the first coupling element of FIG. 1a in the distracted position; and

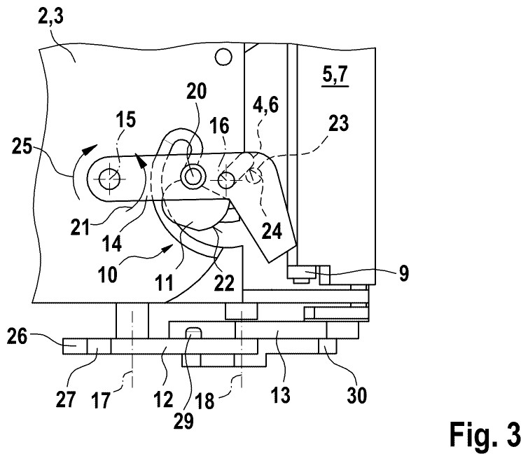

FIG. 3 the drive element is distracted further and the first coupling element is swivel back into the home position.

The air vent 1 according to the invention shown in FIGS. 1 and 2 has a housing 2, which in the example embodiment is flat and rectangular in shape, and which also forms an air duct 3 of the air vent 1. A first set of slats 4 with first slats 4 and a second set of slats 5 with second slats 5 are arranged one behind the other in a flow direction in the air duct 3. The slats 4, 5 can generally also be understood as air deflection elements 6, 7. The slats 4, 5 of each set are arranged parallel to each other next to each other or one above the other in the air duct 3 and can be swiveled about slat axis which run in the longitudinal direction of the slats 4, 5. The swivel axis of the first slats 4 run perpendicular to the swivel axis of the second slats 5.

The slats 4, 5 of each set are connected to coupling rods 8, 9, which are hinged to the slats 4, 5 at a radial distance from the swivel axis of the slats 4, 5 in such a way that the slats 4, 5 of each set swivel together parallel to one another about the swivel axis of the slats 4, 5.

For independent pivoting of the slats 4, 5 of each set, the air vent 1 has a cam gear 10 according to the invention, which has a first coupling element 11 for pivoting the first slats 4 and a second and a third coupling element 12, 13 for pivoting the second slats 5. The slats 4, 5 are driven, i.e. swiveled, by a drive element 14, which in the embodiment example is arranged together with the first coupling element 11 at the top of the housing 2 of the air vent 1. The second and third coupling elements 12, 13 are arranged on the outside of one side of the housing 2 of the air vent 1.

The drive element 14 can be swiveled about a swivel axis, which is referred to here as the drive swivel axis 15 to distinguish it from the other swivel axis. The first coupling element 11 is pivotable about a first swivel axis 16, the second coupling element 12 is pivotable about a second swivel axis 17 and the third coupling element 13 is pivotable about a third swivel axis 18. In the embodiment example, the drive swivel axis 15 runs parallel to the first swivel axis 16 and parallel to the swivel axis of the first slats 4, which are swiveled with the first coupling element 11. In the embodiment example, the second swivel axis 17 and the third swivel axis 18 are also parallel to each other and parallel to the swivel axis of the second slats 5, which can be swiveled with the third coupling element 13. In the embodiment example, the second and third swivel axis 17, 18 are perpendicular to the drive swivel axis 15 and the first swivel axis 16, i.e. the second and third swivel axis 17, 18 run in radial planes of the drive swivel axis 15 and the first swivel axis 16.

To swivel the drive element 14 around the drive swivel axis 15, the air vent 1 a geared motor, i.e. an electric motor 19 with a reduction gear, which is also arranged on the housing 2 of the air vent 1.

To swivel the first coupling element 11, the drive element 14 has a first sensor 20 at a radial distance from the drive swivel axis 15. In the embodiment example, the first sensor 20 is a pin that is movably guided in the drive element 14 parallel to the drive swivel axis 15 and is acted upon in the direction of the housing 2 of the air vent 1 by a spring element that is not visible in the drawing.

When the drive element 14 is swiveled from a basic position, as shown in FIGS. 1 and 1a, in a first swivel direction 21, the first sensor 20 abuts against an edge of the first coupling element 11, this edge forming a first deflection curve 22, which is convexly curved in the embodiment example. When pivoting the drive element in the first swivel direction 21 within a first swivel angle section, the first sensor 20 slides along the first deflection curve 22, which can be understood as “scanning” the first deflection curve 22.

The first coupling element 11 is rigidly connected to one of the first slats 4 in such a way that the first deflection curve 22 has a radial distance from the swivel axis of the first slat 4, which is also the first swivel axis 16 of the first coupling element 11. When scanning the first deflection curve 22, the first sensor 20 swivels the first coupling element 11, the first slat 4 rigidly connected to the first coupling element 11 and, via the first coupling rod 8, the further first slats 4.

The drive element 14 swivels the first coupling element 11 and the first slats 4 as far as the first slats 4 can be swiveled to the maximum, i.e. until the first slats 4 are fully distracted. FIGS. 2 and 2a show the first slats 4 in the fully distracted position. Of course, the first slats 4 can also be swiveled less far. If the drive element 14 is swiveled in a second swivel direction 25 opposite to the first swivel direction 21, it does not swivel the first slats 4, but the first slats 4 remain distracted in the swiveled position that they have previously reached.

If the first slats 4 are distracted to the maximum and cannot be swiveled any further together with the first coupling element 11, and the drive element 14 is swiveled further in the first swivel direction 21, the first deflection curve 22 pushes the first sensor 20, which has a hemispherical end for this purpose, away from the housing 2 of the air vent 1 against the force of its spring element, so that it comes free of the first deflection curve 22. In doing so, the first sensor 20 moves transversely to an extension of the first deflection curve 22, i.e. perpendicular to the first coupling element 11, and in the embodiment example reaches an upper side of the first coupling element 11 facing away from the housing 2 of the air vent 1.

When the first sensor 20 is released from the first deflection curve 22, the drive element 14 moves from the first to a second swivel angle section.

The drive element 14 according the embodiment example has a second pin in greater radial distance from the drive swivel axis 15 than the first sensor 20. The second pin, which in the embodiment example projects rigidly from the drive element 14, forms a first resetter 23, which in the fully distracted position strikes against one of the first slats 4 at a radial distance from the first swivel axis 16 and swivels it back into the home position. FIG. 2a shows the drive element 14 and the first slats 4 or first air deflection elements 6 in the distracted position and the first restoring element 23 shortly before it abuts against one of the first slats 4; FIG. 2 shows the corresponding perspective view.

An edge of the first slat 4, along which the first resetter 23 slides when the first slat 4 is swiveled back, forms a first reset curve 24. The sliding of the first resetter 23 along the first reset curve 24 can also be referred to as “scanning” the first reset curve 24 with the first resetter 23. The swivel angle by which the drive element 14 swivels to return the first coupling element 11 from the fully distracted position to the home position is referred to here as the second swivel angle section.

The drive element 14 is swiveled in the same, namely the first swivel direction 21 for pivoting back the first coupling element 11 as during deflection. The first coupling element 11 is distracted in the first swivel angle section when the drive element 14 is swiveled in the first swivel direction 21 and is swiveled back to the home position in the second swivel angle section when the drive element 14 is swiveled further in the first swivel direction 21. When the drive element 14 itself is swiveled back into its home position in the second swivel direction 25, it does not swivel the first coupling element 11, as described above, so that the slats 4 remain in their respective swiveled position when the drive element 14 is swiveled back into its home position.

FIG. 2a shows the drive element 14 at the transition from the first to the second swivel angle section with the slat 4 at maximum deflection. FIG. 3 shows the drive element 14 at the end of the second swivel angle section and the first slats 4 swiveled back into their home position.

The second and third coupling elements 12, 13 and, via these, the second slats 5 of the other set of slats are swiveled by pivoting the drive element 14 in the second swivel direction 25, in the embodiment example starting from the basic position, as shown in FIGS. 1 and 1a. If—in the embodiment example, starting from the basic position—the drive element 14 is swiveled in the second swivel direction 25, it abuts with its obliquely angled end remote from the drive swivel axis 15 against a first leg 26 of the second coupling element 12, which in the embodiment example has the shape of an L-shaped lever that is pivotable about the second swivel axis 17 at its apex. An edge of the first leg 26 of the second coupling element 12 forms a second deflection curve 27, along which the obliquely angled end of the drive element 14 slides and swivels the second coupling element 12 in a second deflection direction 28 when the drive element 14 is swiveled in the second swivel direction 25 starting from the home position. The sliding of the drive element 14 along the first leg 26 of the second coupling element 12 can also be described as “scanning” the second deflection curve 27.

The second coupling element 12 has a return spring, not shown in the drawing, which urges it back into its home position in such a way that the second coupling element 12 swivels back into its home position if it is not held in a distracted position by the drive element 14.

The second coupling element 12 has a second sensor 29, which is arranged on a second leg 30 of the second coupling element 12 at a radial distance from the second swivel axis 17 of the second coupling element 12. Like the first sensor 20, the second sensor 29 is a pin with a hemispherical end, which is guided in the second coupling element 12 so as to be displaceable parallel to the second swivel axis 17. A spring element, which is not visible in the drawing, acts on the second sensor 29 in the direction of the housing 2 of the air vent 1.

An end edge of the third coupling element 13 facing the second swivel axis 17—at an angle in the embodiment example—forms a third deflection curve 31, along which the second sensor 29 slides and thereby swivels the third coupling element 13 in a third deflection direction 32 when the drive element 14 is swiveled from the home position in a third swivel angle section in the second swivel direction 25 and thereby swivels the second coupling element 12 in the second deflection direction 28.

If the drive element 14 is swiveled further in the second swivel direction 25 and thereby the second coupling element 12 is swiveled further in the second deflection direction 28 in a fourth swivel angle section following the third swivel angle section, the second sensor 29 comes free from the second deflection curve 27 at one end of the end edge of the second coupling element 12 forming the second deflection curve 27 and a second resetter 33, which projects rigidly from the second leg 30 at an end remote from the second swivel axis 17, abuts against a longitudinal edge of the third coupling element 13 and slides along the longitudinal edge of the third coupling element 13 during further pivoting. The longitudinal edge of the third coupling element 13, along which the second resetter 33 slides, can also be referred to as the third reset curve 34 and the sliding of the second resetter 33 along the third reset curve 34 can be understood as “scanning” the third reset curve 34. The scanning of the third reset curve 34 swivels the third coupling element 13 back into its home position. Thus, here too, the pivoting of the drive element 14 in the second swivel direction 25 and the pivoting of the second coupling element 12 caused thereby deflects the third coupling element 13 when the second coupling element 12 swivels in the third swivel angle section, and—with the same swivel direction of the drive element 14 and the second coupling element 12—swivels the third coupling element 13 back into the home position when the second coupling element 12 swivels in the fourth swivel angle section.

The third coupling element 13 swivels with friction in such a way that it does not swivel when the second coupling element 12 is swiveled back against the second deflection direction 28. As a result, the third coupling element 13 can be swiveled into any position and maintains this position when the drive element 14 and the second coupling element 12 are swiveled back. When pivoting back in a return direction opposite to the second deflection direction 28 via the fourth and third swivel angle sections, the second coupling element 12 does not swivel the third coupling element 13.

The third coupling element 13 has an oblong hole 35 extending in its longitudinal direction, into which a pin 36 engages, which projects from one end of a lever 37, which is rigidly arranged on one of the second slats 5 of the second set of slats in such a way that the second slats 5 are swiveled by pivoting the third coupling element 13.

Together with the electric motor 19 or the geared motor, the cam gear 1 according to the invention can also be regarded as a drive unit according to the invention.

### LIST OF REFERENCE SYMBOLS

1 air vent
2 housing
3 air duct
4 first slat
5 second slat
6 first air deflection element
7 second air deflection element
8 first coupling rod
9 second coupling rod
10 cam gear
11 first coupling element
12 second coupling element
13 third coupling element
14 drive element
15 drive swivel axis
16 first swivel axis
17 second swivel axis
18 third swivel axis
19 electric motor
20 first sensor
21 first swivel direction
22 first deflection curve
23 first resetter
24 first reset curve
25 second swivel direction
26 first leg
27 second deflection curve
28 second deflection direction
29 second sensor
30 second leg
31 third deflection curve
32 third deflection direction
33 second resetter
34 third reset curve
35 oblong hole
36 pin
37 lever

The invention claimed is:

1. A cam gear, having a drive element which can be swiveled about a drive swivel axis, and having a first coupling element which can be swiveled about a first swivel axis, wherein the first swivel axis of the first coupling element is at a distance from the drive pivot axis, wherein the drive element has a first sensor at a radial distance from the drive swivel axis and the first coupling element has a first deflection curve which can be scanned by the first sensor of the drive element in such a way in that, starting from a basic position of the drive element and of the first coupling element, when the drive element is swiveled about the drive swivel axis in a first swivel direction within a first swivel angle section, the first sensor of the drive element can scan the first deflection curve of the first coupling element and the first coupling element can be swiveled in a first deflection direction about the first swivel axis into a distracted position, wherein the drive element has a first resetter at a radial distance from the drive swivel axis and the first coupling element has a first reset curve, which, starting from the distracted position of the first coupling element, can be scanned by the first resetter of the drive element in a second swivel angle section when the drive element is swiveled further in the first swivel direction, such that the first coupling element can be swiveled back into the home position about the first swivel axis in a first return direction opposite to the first swivel direction.

2. The cam gear according to claim 1, wherein the cam gear is designed in such a way that the drive element does not displace the first coupling element back over the first and second swivel angle section when the drive element is swiveled about the drive swivel axis in a second swivel direction opposite to the first swivel direction.

3. The cam gear according to claim 1, wherein the first sensor comes free of the first deflection curve of the first coupling element during a transition of the drive element from the first to the second swivel angle section and evades the coupling element by a movement transverse to the extension of the first deflection curve.

4. The cam gear according to claim 1, wherein the first sensor is spring-loaded transversely to the extension of the first deflection cam.

5. The cam gear according to claim 1, wherein the cam gear has a second coupling element which can be swiveled about a second swivel axis and which has a second deflection curve such that that, starting from a basic position of the second coupling element, when the drive element is swiveled about the drive swivel axis in the second swivel direction, the drive element senses the second deflection curve and swivels the second coupling element in a second deflection direction about the second swivel axis into a distracted position.

6. The cam gear according to claim 5, wherein the second coupling element has a second sensor at a radial distance from the second swivel axis, and in that the cam gear has a third coupling element which can be swiveled about a third swivel axis and which has a third deflection curve, in such a way that the second sensor of the second coupling element, when pivoting about the second swivel axis in the second deflection direction in a third swivel angle section, scans the drive element for the third deflection curve of the third coupling element and swivels the third coupling element in a third deflection direction about the third swivel axis into a distracted position.

7. The cam gear according to claim 6, wherein the second coupling element has a second restoring cam at a radial distance from the second swivel axis, and in that the third coupling element has a third restoring cam, in such a way that when the second coupling element is swiveled about the second swivel axis in the second deflection direction in a fourth swivel angle section, the second restoring element of the second coupling element scans the third restoring curve of the third coupling element and the third coupling element swivels back into a basic position about the third swivel axis in a third restoring direction opposite to the third deflection direction.

8. The cam gear according to claim 6, wherein the cam gear is designed in such a way that the second coupling element does not displace the third coupling element over the third and fourth swivel angle section back into the basic position when the second coupling element swivels about the second swivel axis in a fourth swivel direction opposite to the third deflection direction.

9. The cam gear according to claim 6, wherein the second sensor comes free from the third deflection curve of the third coupling element during a transition of the second coupling element from the third to the fourth swivel angle section.

10. The cam gear according to claim 6, wherein the second sensor is spring-loaded transversely to the extension of the third deflection cam.

11. The cam gear according to claim 6, wherein the second coupling element has a return spring which acts on the second coupling element from the distracted position back into a home position.

12. The cam gear according to claim 5, wherein the second swivel axis of the second coupling element and/or the third swivel axis of the third coupling element extend in a radial plane of the drive swivel axis and/or in a radial plane of the first swivel axis of the first coupling element.

13. A drive unit with a cam gear according to claim 1, wherein the drive unit has an electric motor for pivoting the drive element.

14. An air vent, having a first pivotable air deflection element and having a second pivotable air deflection element or a pivotable air volume control element and having a cam gear according to claim 6, wherein the first coupling element and the first air deflection element are rigidly or drive-connected, such that the first coupling element swivels the first air deflection element and/or that the third coupling element and the second air deflection element or the air volume control element are rigidly or drive-connected, such that the third coupling element swivels the second air deflection element or swivels or displaces the air volume control element.
